(19) United States
(12) Patent Application Publication
(10) Pub. No.: US 2021/0237501 A1
(43) Pub. Date: Aug. 5, 2021

(54) A Bound Sheet Device

(71) Applicants: Mike FENNEY, Trimdon (GB); DIVE-LOGS LTD, Trimdon (GB)

(72) Inventor: Michael Fenney, Trimdon (GB)

(21) Appl. No.: 17/054,279

(22) PCT Filed: May 20, 2019
(86) PCT No.: PCT/IB2019/054163

§ 371 Date: Nov. 10, 2020

(30) Foreign Application Priority Data
May 31, 2018 (GB) 1808928.4

(51) Int. Cl. B42F 13/16; B42F 3/06

(52) U.S. Cl. CPC B42F 13/165; B42F 3/06

(57) ABSTRACT

A bound sheet device such as a notebook is disclosed. The notebook includes a back cover and a front cover having multiple perforations aligned adjacent to an edge. The covers have one or more retaining apertures also adjacent to the edge and at one or both ends of the lines of perforations on one or both covers. There are a plurality of pages with multiple perforation corresponding with those on the covers. There is also a helical binder which extends through the perforations. The retaining apertures are different from the perforation and one or both ends of the binder are shaped to fit through the perforation but not the retaining apertures. Thus the binder is reusable allowing pages to be added and removed easily.

The present invention relates to a bound sheet device and relates particularly, but not exclusively, to plastic coil bound notepads.

There are numerous ways of binding sheet materials together. A popular form of binding involves the formation of marginal perforations along one edge of the sheets (normally paper) which are to be bound together and the use of a joining device which is used to hold the sheets together. Such joining devices include plastic and wire combs and also include plastic and wire coils. All of these methods have limited capacity for reusing the binding device or for changing the sheets of material that together form the notepad, book or document. It is often the case that with wire binding, the only way to separate the sheets and remove the wire binding is to distort the wire that forms the binding so much as to render it unusable for a second binding. Although plastic coil binders are better at retaining their shape, the method employed for finishing such a binding makes the process of removing and then re-using the coil binding so awkward and complicated as to render it unworkable and coils are generally cut and then replacement coils are used.

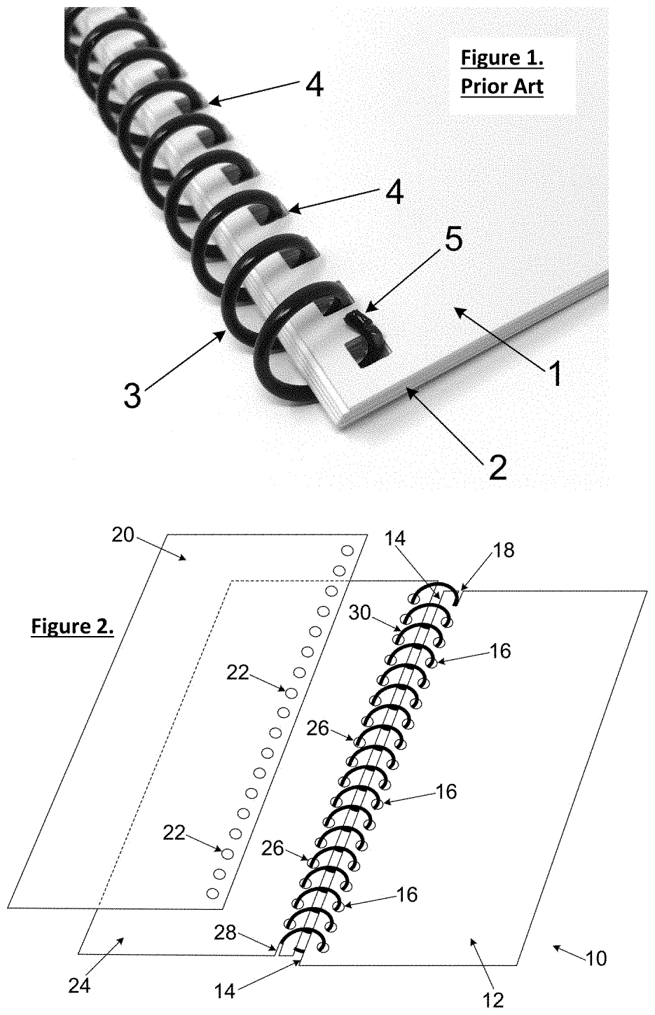

FIG. 1 shows an example of a plastic coil binder of the prior art which includes a cover sheet 1, bound sheets of paper 2 and a plastic helical binder 3 the coils of which extend through marginal perforations 4 in the cover sheet 1 and sheets of paper 2. The end portion 5 of the binder 3 can be seen to have been cut and bent so that it no longer follows the helical shape of the remainder of the binder 3. This deformation of the end portion 5 is achieved with a cutting and bending tool familiar to a person skilled in the art and prevents, during normal use, the end portion 5 from passing through the last of the marginal perforations 4. In order to remove the coil binding 3 from the sheet materials 1 and 2 it is necessary to carefully force the end portion 5 of the binder 3 through each of the marginal perforations 4. If the purpose of removing the binder was to add or replace pages the new pages must be aligned so that the marginal perforations 4 are aligned and then the end portion 5 of the binder 3 is passed through each of the perforations to recreate the binding. Because the process of passing the deformed end portion 5 through each of the perforations is so difficult, this is generally not undertaken and the binder 3 is cut to remove it and replaced with a new binding. This not only means that the original binding is wasted it also requires a supply of binders to be available every time you wish to add or remove pages. Additionally, the process of altering the binding would usually require some form of tool or machine to form the deformation of the end portion 5; it is not generally something that can be done quickly and easily by hand.

An example of a device which attempts to address the problem set out above is disclosed in US patent document U.S. Pat. No. 5,417,508. However, such a device would not work with the coil binders of the type shown in FIG. 1 which are too narrow in diameter to accommodate the additional locking device.

Preferred embodiments of the present invention seek to overcome or alleviate the above described disadvantages of the prior art.

According to an aspect of the present invention there is provided a bound sheet device comprising:—

a first sheet material having a plurality of first main apertures aligned adjacent a first edge thereof and a first retaining aperture adjacent said first edge and at one end of said line of first main apertures;
a plurality of second sheet materials having a plurality of second main apertures corresponding with said first main apertures; and
a binder having a substantially uniform helical shape, wherein said first retaining aperture is different from said first and second main apertures and at least one end of said binder is shaped to fit through said first and second main apertures but does not fit through said first retaining aperture when the binder is in an alignment corresponding with said main apertures, said shaped end of said binder passes through said first retaining aperture by temporarily deforming said binder helical shape and said first sheet material is rigid such that said shaped end of said binder is, when back to its original helical shape in use, retained in position.

By providing a bound sheet device with differently shaped apertures to retain a helical binding, an end of which has been shaped to prevent it from passing through the differently shaped apertures, significant advantages are provided. For example, the binding can be easily disassembled allowing pages in the notepad, book or document to be easily added, removed or replaced. When the re-binding process is to take place the original coil binding can be easily reused and does not need replacing. This has advantages when documents are first being put together as more pages can be easily inserted. Furthermore, it allows some products to be sold as a kit of parts with the option of adding or replacing pages by hand. One example where this invention can be usefully utilised is in a form of notebooks known as “dive logs” or “wet notes”. These notebooks are used by scuba divers to record notes about dives which they take part in and it is useful to be able to add, remove and replace pages in a dive log as and when required.

The first retaining aperture may comprise a first slot.

In a preferred embodiment the first slot extends from a second edge of said first sheet material extending from said first edge.

In another preferred embodiment the first slot extends from a first slot aperture located at an end of said slot distal of said first main apertures.

The device may further comprise a second retaining aperture shaped differently from said first main apertures such that said shaped end of said binder does not fit through said second retaining aperture when said binder is in alignment corresponding with said main apertures.

By having a second retaining aperture, and as a consequence shaping both ends of the binder to be retained by the retaining apertures, the advantage is provided that the binder is held in place at both ends. As a result, the coil binder fulfils its normal function but can be easily removed from engagement with the sheet materials. Furthermore, because the binder is symmetrical it can be inserted into the sheet material starting at either end of the sheets with either end of the binder.

The second retaining aperture may be formed in said first sheet material.

In a preferred embodiment the second retaining aperture comprises a second slot.

In another preferred embodiment the second slot extends from a third edge of said first sheet material extending from said first edge.

In a further preferred embodiment the second slot extends from a second slot aperture located at an end of said slot distal of said first main apertures.

The device may further comprise a third sheet material having a plurality of third main apertures, adjacent to a fourth edge, corresponding with said first and/or second main apertures.

The second retaining aperture may be formed in said third sheet material.

In a preferred embodiment the second retaining aperture comprises a second slot.

In another preferred embodiment the second slot extends from a fifth edge of said third sheet material extending from said fourth edge.

In a further preferred embodiment the second slot extends from a third slot aperture located at an end of said slot distal of said third main apertures.

The first sheet material may be less flexible than said second sheet material.

In a preferred embodiment the first sheet material is substantially rigid.

In another preferred embodiment all of the sheet materials are substantially the same size.

According to another aspect of the present invention there is provided a method of forming a bound sheet device comprising the steps of:—

taking components of a bound sheet device as set out above;
arranging the first and second sheet materials such that the first and second main apertures are aligned;
inserting said shaped end of said binder into an aligned first and second main aperture;
rotating said binder in a first rotational direction such that said shaped end passes through adjacent main apertures; and
distorting said binder such that said shaped end can pass into said first retaining aperture and is retained by said aperture and prevented from rotating in a second rotational direction opposite to said first rotational direction.

Preferred embodiments of the present invention will now be described, by way of example only, and not in any limitative sense with reference to the accompanying drawings in which:—

FIG. 1 is a notepad of the prior art;

FIG. 2 is a perspective view of a bound sheet device of the present invention;

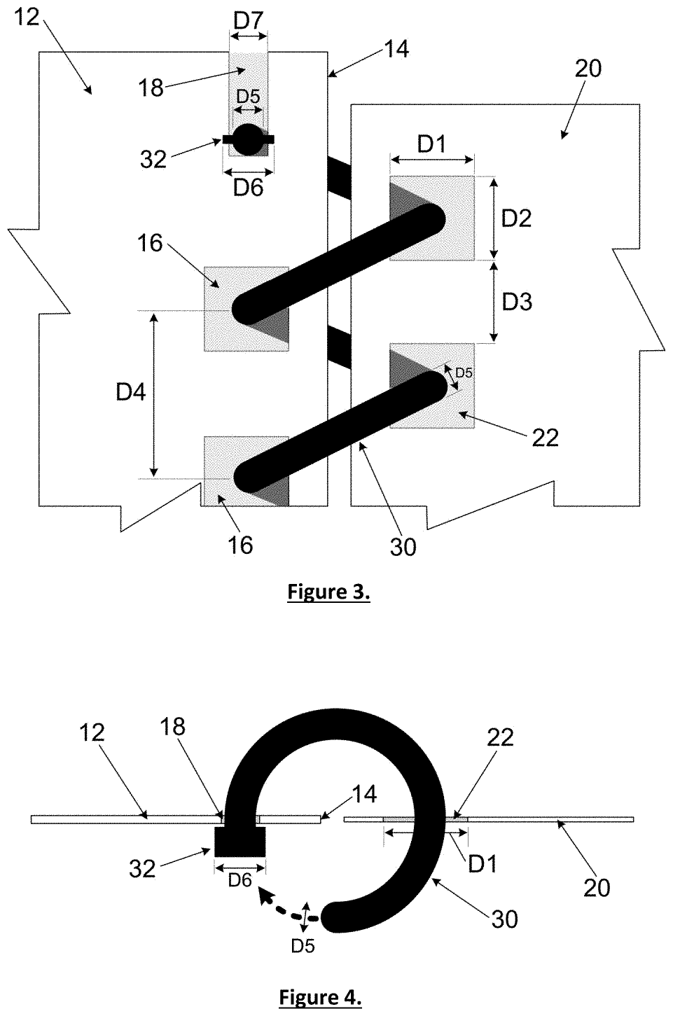

FIG. 3 is a close-up partial plan view of the device of FIG. 2;

FIG. 4 is a close-up partial side view of the device of FIG. 2;

FIG. 5 is a partial view of the device of FIG. 2 demonstrating an operational aspect of the invention;

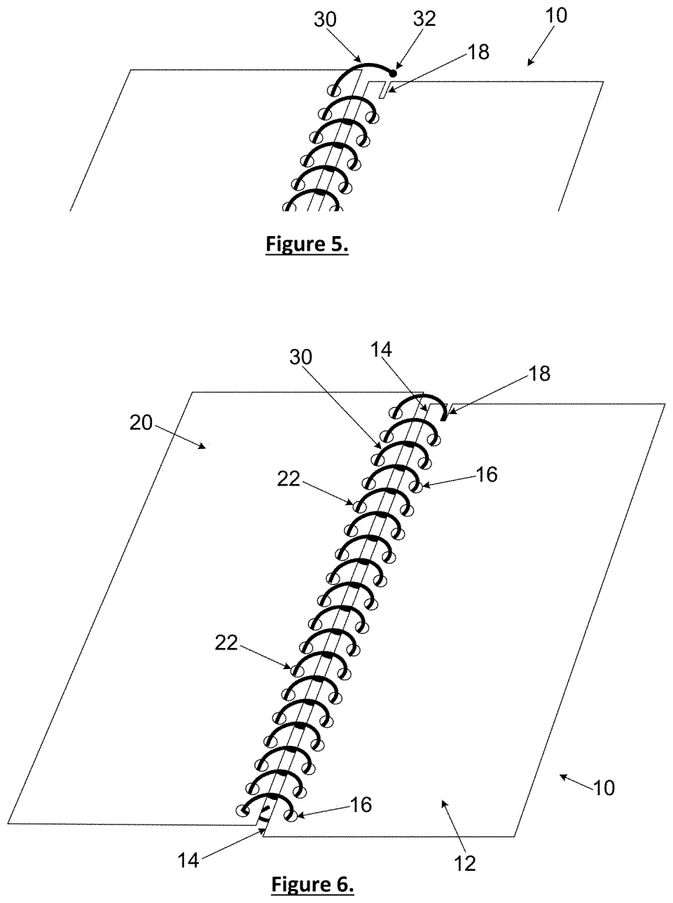

FIG. 6 is a perspective view of an alternative embodiment of the bound sheet device of the present invention;

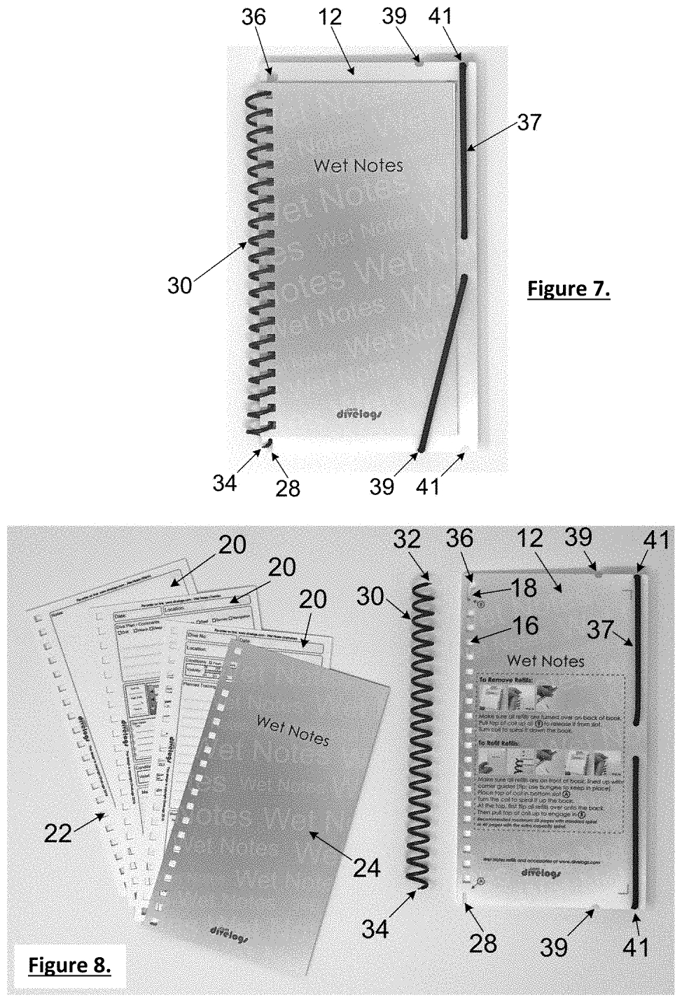

FIGS. 7 and 8 are planned views of a further embodiment of the bound sheet device of the present invention shown in assembled and disassembled conditions respectively; and

FIGS. 9 to 11 are partial views of components of bound sheet devices of further alternative embodiments of the present invention.

Referring to FIGS. 2 to 4, a bound sheet device, in the form of a notepad 10, has a first sheet material, in the form of a backing board 12. Located along a first edge 14 of the backing board 12 are a plurality of first main apertures, in the form of perforations 16. Also adjacent to the first edge 14 and located at one end of the line of first perforations is a first retaining aperture in the form of first slot 18.

Further components of the notepad 10 are a plurality of second sheet materials, in the form of pages 20, which have a plurality of second main apertures, in the form of second perforations 22, that correspond with the first perforations in the backing board 12. In the embodiments described herein the term corresponding is used to indicate that the first and second perforations have substantially the same location relative to and adjacent the edges of the backing board 12 and pages 20 respectively and that they are approximately the same in number, that is that they align with one another. However, it should be noted that there is generally one less first perforation (on the backing board 12) than there are second perforations 22 (on the pages 20) due to the inclusion of the first slot 18 in the backing board. It is preferable that the first and second perforation are the same shape and size, thus making alignment easy. However, this is not essential and small variation in shape and size can be accommodated, for example, similarly sized square and circular perforations can work together.

Although not essential, it is typical that a third sheet material, in the form of a front cover 24 is also provided and has a plurality of third main apertures in the form of third perforations 26 which correspond with the first and second perforations 16 and 22. In addition to the third perforations 26 the front cover 24 also has a second retaining aperture in the form of a second slot 28

The final main component of the notepad 10 is a plastic coil binder 30 which has a substantially uniform helical shape and is formed from thermoplastic material in a manner familiar to person skilled in this field. The binder has a substantially circular cross-section which is commonly distorted by the process of forming the helical shape and results in a slight ovaling of the cross-section. The binder coil 30 is produced in lengths significantly longer than required for the notepad 10 and is cut to the length required. However, in contrast to the cutting and bending action utilised in the prior art, the cutting of the coil binder 30 should not result in any bending out of alignment with the helix which forms the coil.

A first end 32 of the coil binder 30 is shaped to act as a retaining portion. One method of forming the retaining portion at the first end 32 of the coil binder 30 is to use a pair of pliers to squeeze the first end which causes it to flatten and increase the width to be greater than the diameter of the cross-section of the coil binder.

The relative dimensions of some aspects of the components of the present invention are important to its correct function and these are set out below. In the example shown in FIG. 3, the first, second and third perforations have a substantially square formation with sides of length D1 and D2 and the spaces between each of the perforations is indicated as dimension D3. As a result, and in order to allow the best functioning of the invention, the pitch length D4 of the coil is equal to the sum of D2 and D3. The diameter of the cross-section of the coil binder 30 is indicated as D5. Due to the distortion of the cross-section of the coil it is more correct to state that D5 is the length of the minor axis of the oval cross-section which is narrower in the vertical direction than the horizontal direction as shown in FIG. 3. The compressed, or flattened, first end portion 32 of coil binder 30 has a length indicated as D6 which is greater than D5. Finally, the first slot 18 has a width D7. That width D7 is measured perpendicular to the first edge 14 of the backing board 12 into which the slot 18 is formed.

As can be seen in FIG. 3, the first end 32 of binder 30 is able to fit through the first and second perforations 16 and 22 (and also through the third perforations 26) because the width D6 of the first end 32 of binder 30 is less than the dimensions D1 and D2 of the perforations. However, when the binder 30 is in an alignment corresponding with the main apertures 16 and 22 the first end 32 of the binder 30 is unable to fit through the first slot 18 because the width D6 of the first end 32 is greater than the width D7 of the slot 18. An example of the binder 30 being in an alignment corresponding with the main apertures 16 and 22 is shown in FIGS. 2 and 4 that is when the binder is in a normal working condition with the first end 32 of the binder 30 extending perpendicular to the length of the slot 18.

Operation of the notepad 10 will now be described. In this first example the notepad 10 includes a backing board 12, plurality of pages 20 and a front cover 24. All of these sheet materials are substantially the same size and have the same shaped perforations along one edge. Typically, the front cover 24 and back board 12 are formed from a material that is stiffer than the pages 20 and is sufficiently stiff (or rigid) to ensure that the first and second ends 32 and 34 of the coil binder 30 do not get pulled back through the first and second slots 18 and 28 in normal use of the notepad. In this embodiment the backing board 12 and front cover 24 are the same shape with the same number of perforations (that is first perforations 16 on the backing board 12 and third perforations on the front cover 24) this being one less the second perforations 22 on the pages 20. On both the backing board 12 and front cover 24 the last perforations have been replaced by a slot, that being the first slot 18 and second slot 28 respectively.

In order to construct the notepad 10, the pages 20 are all aligned so that the second perforations are all aligned with one another. The backing board 12 is also aligned so that the majority of the first perforations in line with the second perforations and the same arrangement is made for the front cover 24 with the third perforations 26 aligned with the second perforations 22. However, the backing board 12 and front cover 24 are arranged so that the first and second slots 18 and 28 are at opposing ends of the notepad 10 and the slots are aligned with the first and last second perforations 22 of the pages 20. On the binder 30 both the first end 32 and the second end 34 have been deformed by compression by pliers in order to form a flat portion with a width D6 which is greater than the width D7 of the slots 18 and 28.

To wind the coil binder 30 onto the backing board 12, pages 20 and front cover 24, the front cover 24 is lifted slightly at the corner where the second slot 28 is located so as to expose the first of the second perforations 22 in the pages 20 which are hidden by the second slot 28. The first end 32 of the coil binder 30 is inserted into the first of the second perforations 22. Once the coil binder 30 is within the first of the second perforations 22 the front cover can be released and binder 30 arranged such that it freely passes through slot 28. Since the first perforations 16, the second perforations 22 and the third perforations 26 are all aligned with each other the individual perforations in each of these sheet materials are grouped together. Rotation of the coil binder 30 causes the first end 32 to pass through the second of the grouped perforation and further rotation causes the first end to pass through the next and each subsequent grouped perforation until the coil binder has been almost completely loaded onto the notepad 10. The first end 32 of the coil binder 30 is able to pass easily through the grouped perforations because the dimensions D1 and D2 of the perforations are larger than the width D6 of the first end.

The first end 32 of the coil binder 30 is able to pass through the last of the perforations in the front cover 24 and the pages 20 (that is the third perforations 26 and the second perforations 22) but because the width D7 of the first slot 18 is less than the width D6 of the compressed first end 32 it cannot pass through the first slot when the binder is in an alignment corresponding with the perforations, that being the coil binder having been wound onto the group perforations. In order to engage the coil binder 30 with the first slot 18 the notebook 10 is opened so that the backing board 12 is separate from the pages 20 and the front cover 24 as shown in FIG. 5. Because the coil binder is made of a flexible thermoplastic the last coil of the binder, and in particular the first end 32, can be lifted beyond the open end of slot 18. The first end 32 is then passed beyond the plane of the backing board 12 and lowered into the first slot 18 so that the coil binder 30 passes through the slot 18 with the first end 32 extending through to the rear side of the backing board 12. Because of the helical shape of the binder 30 it can deform sufficiently to pass into the slot 18 and flex back without undergoing permanent deformation.

If it is later desired to add, remove or replace pages, this can be easily achieved by removing the binder coil 30 from the front cover 24, pages 20 and backing board 12. The process is the reverse of that set out above. One of the first or second ends 32 and 34 are removed from the first and second slots 18 and 28 by stretching the ends of the coil beyond the edges of the front cover 24 and backing board 12 into which the first and second slots are cut. The coil binder 30 is then rotated such that one of the first or second ends 32 or 34 passes through the grouped perforations until it is removed. As a result, the coil binder 30 has been easily removed without any damage to it.

It will be appreciated by persons skilled in the art that the above embodiments have been described by way of example only and not in any limitative sense, and that various alterations and modifications are possible without departure from the scope of the protection which is defined by the appended claims. For example, the example shown in FIG. 6 uses the present invention on the backing board 12 only and the second end 34 has been retained in the manner described in relation to the prior art and shown in FIG. 1. As a result, if it is desired to remove the coil binder 30 from the notepad the first end 32 can be removed from the first slot 18 in the manner described above and then it is only necessary to guide the second end 34 past the bottom most edge of the notepad 10 to allow the coil binder 30 to be freely rotated with the first end 32 passing through the group perforations.

Another alternative embodiment is shown in FIGS. 7 and 8. This bound sheet device is a notepad, specifically known as Wet Notes used by scuba divers to make notes during the course of a dive. As with the previous embodiments, this notepad 10 includes a backing board 12, pages 20 and a front cover 24 and all of these components are designed to retain their strength and other properties when wet. However, in this instance the backing board 12 is larger than the pages 20 and front cover 24 and is formed from a rigid material thereby acting as a solid base against which to press when writing on the pages. Another difference with the backing board 12 is that both the first slot 18 and second slot 28 are located in this component meaning that the front cover only contains the standard third perforations 26. As a result, the backing board 12 shown in FIG. 8 could be used with any suitable pages and front cover from a notepad that have perforations which can be aligned with the first perforations 16 on the backing board. Clearly for the purposes of a Wet Notes type notepad the pages and front cover would need to be of a type suitable for use in the water. As can be seen in FIG. 8 the first slot 18 does not extend to the upper edge of the backing board 12 but instead ends in an aperture 36 of a similar size to the first, second and third perforations. This aperture 36 allows the first end 32 of the coil binder 30 to extend through to the rear side of the backing board 12 and the coil to enter the slot 18 with the first end 32 extending through to the rear side. A close-up example of this aperture 36 and slot 18 together form a shape resembling a “P” and this is shown in FIG. 9 although with the aperture and slot reversed compared to the version shown in FIG. 8. An additional function of the aperture 36 is that it allows a lanyard to be attached to the backing board 12 so that the notepad can be attached to the diver. A further additional component in this embodiment is the page bungee 37 which is used to hold the notepad closed when it extends into the notches 39 and allows the pages to be turned when in the notches 41.

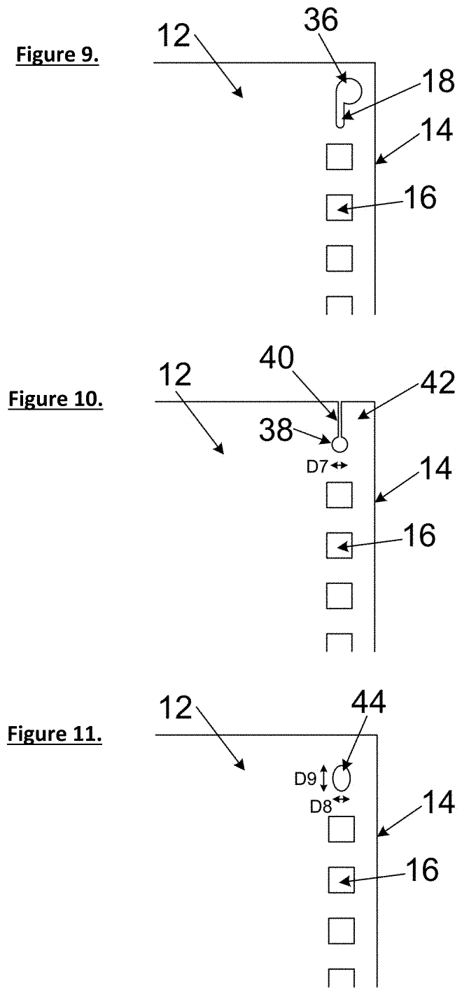

Two further alternative embodiments of the backing board 12 are shown in FIGS. 10 and 11. In the example shown in FIG. 10 the slot 18 has been replaced with an aperture 38 and a cut 40. The aperture 38 has a diameter D7, measured perpendicular to the first edge 14, which is greater than the diameter D5 of the coil 30 but less than the width D6 of the first end portion 32. As a result, when the coil binder 30 is in position and the first end 32 extends through the aperture 38 the first end is too wide to pass back through the aperture 38. In this instance the backing board 12 must be sufficiently stiff so that the first end 32 of the coil binder 30 cannot be pulled back through the aperture 38 in normal use whilst being sufficiently flexible that the corner portion 42 of the backing board 12 can be flexed out of the way so that the cut 40 opens up sufficiently to allow the portion of the coil binder 30 immediately adjacent to the first end 32 to pass along the cut 40 and into the aperture 38 and then flex back thereby causing the corner 42 to be coplanar with the remainder of the backing board 12 thereby closing the cut 40 around the coil binder.

In the embodiment depicted in FIG. 11, the first slot has been replaced with an oval aperture 44 which has a diameter D8 at the minor axis and a diameter D9 at the major axis with the major axis running parallel to the first edge 14. The diameter D8 of the minor axis is greater than the diameter D5 of the coil binder 30 but is less than the diameter D6 of the first end 32. Because the coil binder 30 may deform during its production to form an oval cross-section, D8 may need to be greater than the major axis of that cross-section. The diameter D9 of the major axis of the oval aperture 44 is greater than the width D6 of the first end 32 of the coil binder 30. For this oval aperture 44 to operate it is necessary for the first end 32 to rotate through 90° in order that the greater width of the first end can enter that aperture. Once the first end 32 is through the aperture 44 the coil binder 30 can be rotated so that it is in an alignment corresponding with the perforations (that is, aligned ready to be rotated onto the perforations). Because the thermoplastic from which the coil binder 30 is formed is quite rigid it is very difficult to rotate the first end 32 through 90° without rotating the whole of the coil binder 30. As a result, this embodiment is only really practical to be used to one end of the front cover 24 or backing board 12 and it is generally the case that the whole coil is rotated through 90° inserted into the oval aperture 44 then rotated back through 90° into its standard alignment, corresponding with the perforations, to allow the coil binder to be rotated into full engagement with all of the perforations.

Although the coils have been described above as plastic coil binders they can be formed from other materials including, but not limited to, metal, such as metal wire, and plastic-coated metal wire. Furthermore, the method of forming the first end 32 of the coil binder 30 may be varied from that described above of simply flattening the end using pliers. For example, heating the thermoplastic material at the end that has been cut, or as part of the cutting process, can be used to form a blob of plastic at the end of the coil. Likewise, a small component can be adhered to the end of the coil binder. In both of these cases the size of the blob or component must be such that it can easily pass through the first, second and third perforations but cannot pass through the slot 18 (or the like component).

1. A bound sheet device comprising:—
a first sheet material having a plurality of first main apertures aligned adjacent to a first edge thereof and a first retaining aperture adjacent to said first edge and at one end of said line of first main apertures;
a plurality of second sheet materials having a plurality of second main apertures, corresponding with said first main apertures; and
a binder having a substantially uniform helical shape, wherein said first retaining aperture is different from said first and second main apertures and at least one end of said binder is shaped to fit through said first and second main apertures but does not fit through said first retaining aperture when in an alignment corresponding with said main apertures, said shaped end of said binder passes through said first retaining aperture by temporarily deforming said binder helical shape and said first sheet material is rigid such that said shaped end of said binder is, when back to its original helical shape in use, retained in position.

2. A device according to claim 1, wherein said first retaining aperture comprises a first slot.

3. A device according to claim 2, wherein said first slot extends from a second edge of said first sheet material extending from said first edge.

4. A device according to claim 2, wherein said first slot extends from a first slot aperture located at an end of said slot distal of said first main apertures.

5. A device according to any preceding claim, further comprising a second retaining aperture shaped differently from said first main apertures such that said shaped end of said binder does not fit through said second retaining aperture when said binder is in alignment corresponding with said main apertures.

6. A device according to claim 5, wherein said second retaining aperture is formed in said first sheet material.

7. A device according to claim 5 or 6, wherein said second retaining aperture comprises a second slot.

8. A device according to claim 7, wherein said second slot extends from a third edge of said first sheet material extending from said first edge.

9. A device according to claim 7, wherein said second slot extends from a second slot aperture located at an end of said slot distal of said first main apertures.

10. A device according to any preceding claim, further comprising a third sheet material having a plurality of third main apertures, adjacent to a fourth edge, corresponding with said first and/or second main apertures.

11. A device according to claims 1 to 4, further comprising a third sheet material having a plurality of third main apertures, adjacent to a fourth edge, corresponding with said first and/or second main apertures and a second retaining aperture is formed in said third sheet material.

12. A device according to claim 11, wherein said second retaining aperture comprises a second slot.

13. A device according to claim 12, wherein said second slot extends from a fifth edge of said third sheet material extending from said fourth edge.

14. A device according to claim 12, wherein said second slot extends from a third slot aperture located at an end of said slot distal of said third main apertures.

15. A device according to any preceding claim, wherein all of said sheet materials are substantially the same size.

16. A method of forming a bound sheet device comprising the steps of:—
taking components of a bound sheet device according to any of the preceding claims;
arranging the first and second sheet materials such that the first and second main apertures are aligned;
inserting said shaped end of said binder into an aligned first and second main aperture;
rotating said binder in a first rotational direction such that said shaped end passes through adjacent main apertures; and
distorting said binder such that said shaped end can pass into said first retaining aperture and is retained by said aperture from rotating in a second rotational direction opposite to said first rotational direction.

17. A bound sheet device comprising:—
a first sheet material having a plurality of first main apertures aligned adjacent a first edge thereof and a first retaining aperture adjacent said first edge and at one end of said line of first main apertures;
a plurality of second sheet materials having a plurality of second main apertures corresponding with said first main apertures; and
a binder having a substantially uniform helical shape, wherein said first retaining aperture is different from said first and second main apertures and at least one end of said binder is shaped to fit through said first and second main apertures but does not fit through said first retaining aperture when the binder is in an alignment corresponding with said main apertures.
